(19) United States
(12) Patent Application Publication
(10) Pub. No.: US 2010/0220651 A1
(43) Pub. Date: Sep. 2, 2010

(54) Method and apparatus for broadcasting and receiving system information in OFDMA systems

(75) Inventors: Yih-Shen Chen, Hsinchu City (TW); Pei-Kai Liao, Mingjian Xiang (TW); Chih-Yuan Lin, Wujie Township (TW)

Correspondence Address: IMPERIUM PATENT WORKS, P.O. BOX 607, Pleasanton, CA, 94566, US

(73) Assignee: MediaTek Inc.

(21) Appl. No.: 12/660,440

(22) Filed: Feb. 26, 2010

Related U.S. Application Data
(60) Provisional application No. 61/156,576, filed on Mar. 2, 2009.
(60) Provisional application No. 61/172,326, filed on Apr. 24, 2009.

(51) Int. Cl. H04W 40/00; H04J 1/00

(52) U.S. Cl. 370/328; 370/343

(57) ABSTRACT

A method for broadcasting system information via a broadcast channel (BCH) in an OFDMA system is provided. The BCH comprises one or more two-dimensional resource blocks. A plurality of pilot tones and a plurality of data tones are positioned within each resource block. The system information is mapped onto the plurality of data tones. In one embodiment, the plurality of pilot tones are located in configurable positions such that pilot tones of the same resource blocks transmitted by different base stations in the OFDMA system are interlaced to reduce pilot-to-pilot collision. In another embodiment, data tones that are located in pilot positions of other adjacent cells are nullified to reduce data-to-pilot collision. In one novel aspect, the property of interlaced pilot patterns and tone nullification is leveraged to estimate interference second-order statistics, which facilitates receiver implementation and improves receiver performance.

### CROSS REFERENCE TO RELATED APPLICATIONS

This application claims priority under 35 U.S.C. §119 from U.S. Provisional Application No. 61/156,576, entitled “OFDMA System,” filed on Mar. 2, 2009; U.S. Provisional Application No. 61/172,326, entitled “Receiver Architecture for OFDMA Network with FR=1,” filed on Apr. 24, 2009; the subject matter of which is incorporated herein by reference.

### TECHNICAL FIELD

The disclosed embodiments relate generally to wireless network communications, and, more particularly, to broadcast channel design in wireless orthogonal frequency division multiple access (OFDMA) communication systems.

### BACKGROUND

In cellular orthogonal frequency division multiple access (OFDMA) communication systems, each base station broadcasts a set of essential system information such as cell identification information, network entry/reentry information, sleep mode operation parameters, and other broadcasting announcement to mobile stations. The set of system information is conveyed by a common broadcast channel (BCH), also referred as superframe header (SFH) in the IEEE 802.16m specification. Typically, a mobile station has access to the system information after performing downlink (DL) synchronization with its serving base station.

There are two different options available for SFH broadcasting. In a first option of SFH broadcasting with cell planning, each base station broadcasts the SFH information using different frequency subcarriers among neighboring base stations. For example, frequency reuse three is applied for SFH transmission such that there is no SFH interference coming from three neighboring cells. In a second option of SFH broadcasting without cell planning, frequency reuse one is applied for SFH transmission and the SFH information is transmitted over the same frequency subcarriers among cells. While SFH broadcasting with cell planning eliminates SFH interference from other cells, cell planning requires large maintenance and operation cost and has low deployment flexibility. On the other hand, while SFH without cell planning suffers undesirable inter-cell interference, it provides easy and flexible system deployment.

In OFDMA systems, interference is typically caused by collision between pilot tones and data tones transmitted over the same radio resource blocks. In general, the collision of pilot tones is more server than that of data tones. This is because the collision of pilot tones results in poor channel estimation and thus degrades the decoding performance of data tones. Therefore, if the issue of pilot tone collision is effectively resolved, then SFH without cell planning will be a preferable choice with improved system performance.

### SUMMARY

A method for broadcasting system information via a broadcast channel (BCH) in an OFDMA system is provided. The BCH comprises one or more two-dimensional resource blocks. Each resource block has an array of subcarriers along frequency domain and an array of OFDM symbols along time domain. A plurality of pilot tones and a plurality of data tones are positioned within each resource block. The pilot tones are used to facilitate channel estimation, while the data tones are used to carry the actual content of system information.

In one embodiment, the plurality of pilot tones are located in configurable positions such that pilot tones of the same resource blocks transmitted by different base stations in the OFDMA system are interlaced to reduce inter-cell pilot-to-pilot collision. The selection of pilot patterns can be a function of cell identification (cell ID) information. In one example, each cell positions its pilot tones in interlaced locations of the same resource block based on its cell ID. By having interlaced pilot patterns for adjacent cells, channel estimation quality in each cell is much improved because of reduced interference on pilot tones. In addition, power boosting for pilot tones can further improve channel estimation quality.

In another embodiment, data tones that are located in pilot positions of other adjacent cells are nullified so that they are no longer available for data transmission. By nullifying data tones located in pilot positions of other adjacent cells, interference on pilot tones due to inter-cell data-to-pilot collision is reduced, and channel estimation quality is improved.

In yet another embodiment, system information is repeated in frequency domain or time domain or both to improve detection reliability. Different 2D repetition patterns are communicated to the mobile stations. In one embodiment, system information is mapped into a first information bit stream and a second information bit stream. The first information bit stream indicates a 2D repetition pattern, while the second information bit stream carriers the actual content of system information. Upon receiving the broadcasted system information, the mobile stations decode the first information bit stream and derive the 2D repetition pattern, and then decode the second information bit stream and retrieve the content of system information according to the 2D repetition pattern. In one preferred embodiment, the 2D repetition pattern is represented by modulation and coding (MCS) information.

In one novel aspect, the property of interlaced pilot patterns is leveraged to estimate second-order statistics of dominant interfering sources, which facilitates receiver implementation and improves receiver performance. In one embodiment, a mobile station receives a composite radio signal composed of a first radio signal and a plurality of interfering radio signals. The first radio signal is transmitted by its serving base station using a first pilot pattern. The plurality of radio signals are transmitted by a plurality of interfering base stations using a plurality of corresponding pilot patterns. The first pilot pattern and the plurality of pilot patterns are predefined and interlaced. The mobile station estimates a first channel response of the serving BS based on the first pilot pattern. The mobile station also estimates a plurality of channel responses of the plurality of the interfering BSs based on the plurality of corresponding pilot patterns. By using different pilot patterns to estimate different channel responses from different base stations, the overall performance of channel estimation is improved. In order to achieve optimal receiver performance, the mobile station estimates second-order statistics of remaining interfering sources based on the interlaced pilot patterns if tone nullification is also applied on the transmitter side.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a broadcast channel (BCH) in a wireless OFDMA system in accordance with one novel aspect.

FIG. 2 is a flow chart of a method of broadcasting system information in accordance with one novel aspect.

FIG. 3 illustrates one example of interlaced pilot pattern in broadcasting system information.

FIG. 4 illustrates one example of null-tone based interlaced pilot pattern in broadcasting system information.

FIG. 5 illustrates one example of pilot power boosting in broadcasting system information.

FIG. 6 illustrates different examples of 2D repetition in broadcasting system information.

FIG. 7 illustrates a wireless OFDMA system in accordance with one novel aspect.

FIG. 8 illustrates a simplified block diagram of a receiver with interlaced pilot pattern exploitation for channel estimation and compensation.

FIG. 9 is a flow chart of a method of channel estimation and compensation in accordance with a novel aspect.

### DETAILED DESCRIPTION

Reference will now be made in detail to some embodiments of the invention, examples of which are illustrated in the accompanying drawings.

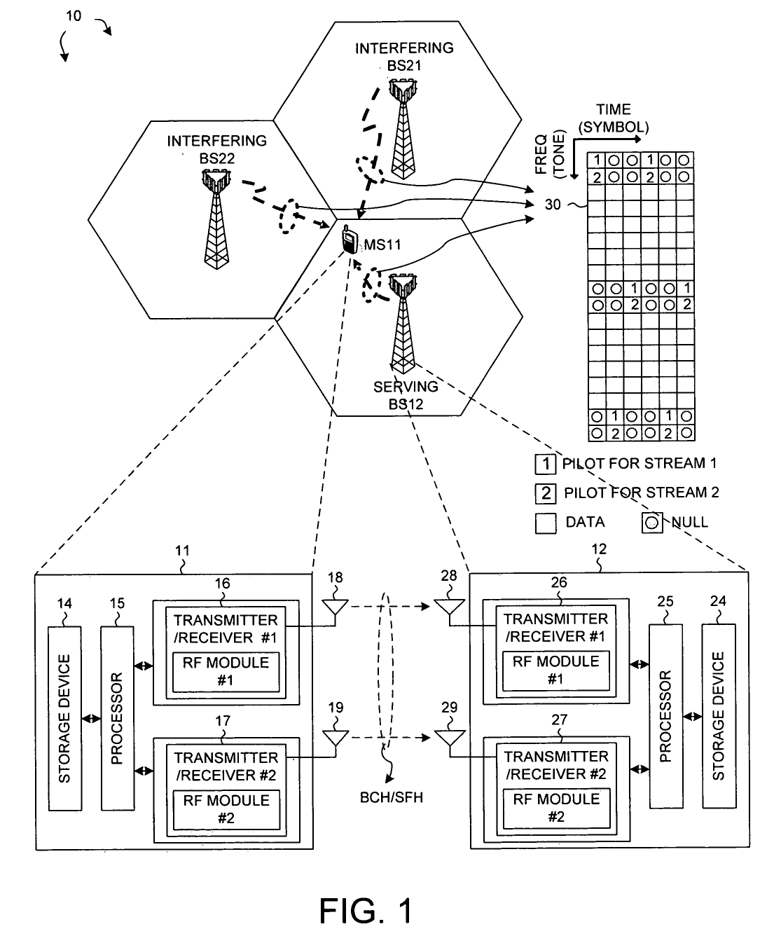

FIG. 1 illustrates a broadcast channel (BCH) in a wireless OFDMA system 10 in accordance with one novel aspect. Wireless OFDMA system 10 comprises a mobile station MS11, a serving base station BS12, and two interfering base stations BS21 and BS22. MS11 comprises a storage device 14, a processor 15, a first transmitter and receiver 16 coupled to a first antenna 18, and a second transmitter and receiver 17 coupled to a second antenna 19. Similarly, BS12 comprises a storage device 24, a processor 25, a first transmitter and receiver 26 coupled to a first antenna 28, and a second transmitter and receiver 27 coupled to a second antenna 29. In wireless OFDMA system 10, each base station BS12, BS21 and BS22 broadcasts a set of essential system information such as cell identification information, network entry/reentry information, sleep mode operation parameters, and other broadcasting announcement to all mobile stations located in wireless OFDMA system 10. The set of system information are conveyed by a common broadcast channel (BCH), also referred as superframe header (SFH) in the IEEE 802.16m specification.

As illustrated in FIG. 1, the BCH comprises one or more two-dimensional radio resource blocks to broadcast the SFH information. Each resource block (for example, resource block 30) comprising a number of consecutive subcarriers (also referred as frequency tones) along frequency domain and a number of consecutive OFDM symbols (also referred as time slots) along time domain. The SFH information may be broadcasted either with or without cell planning. In advanced wireless systems such as cdmaOne, WCDMA, CDMA2000, and IEEE 802.16m, SFH transmission without cell planning is adopted to reduce large maintenance and operation cost and to increase deployment flexibility. When the SFH information is broadcasted without cell planning, however, frequency reuse one (FR=1) is applied for each base station and thus introduces undesirable inter-cell interference among different base stations. This is because under frequency reuse one, the SFH information is transmitted via a common BCH over the same physical radio resource spectrum. In the example of FIG. 1, BS12, BS21, and BS22 all use the same resource block 30 to broadcast system information. Thus, MS11 not only receives radio signals carrying system information broadcasted from its serving base station BS12, it also receives interfering radio signals carrying system information broadcasted from interfering base stations BS21 and BS22. Moreover, in a multi-cell environment, such inter-cell interference becomes worse when MS11 moves toward the cell boundary.

As illustrated in FIG. 1, resource block 30 comprises a plurality of pilot tones and a plurality of data tones. The pilot tones are used to facilitate channel estimation, while the data tones are used to carry the actual system information. Typically, inter-cell interference is caused by collision between both pilot tones and data tones. When pilot tones are affected by other pilot and data tones, the performance of channel estimation deteriorates. When data tones are affected by other pilot tones, the performance of data decoding rate deteriorates. In general, the collision of pilot tones is more server than that of data tones because the collision of pilot tones results in poor channel estimation and thus degrades the decoding performance of data tones. In one novel aspect, the BCH in OFDMA system 10 is designed for broadcasting system information in such a way that inter-cell interference is reduced.

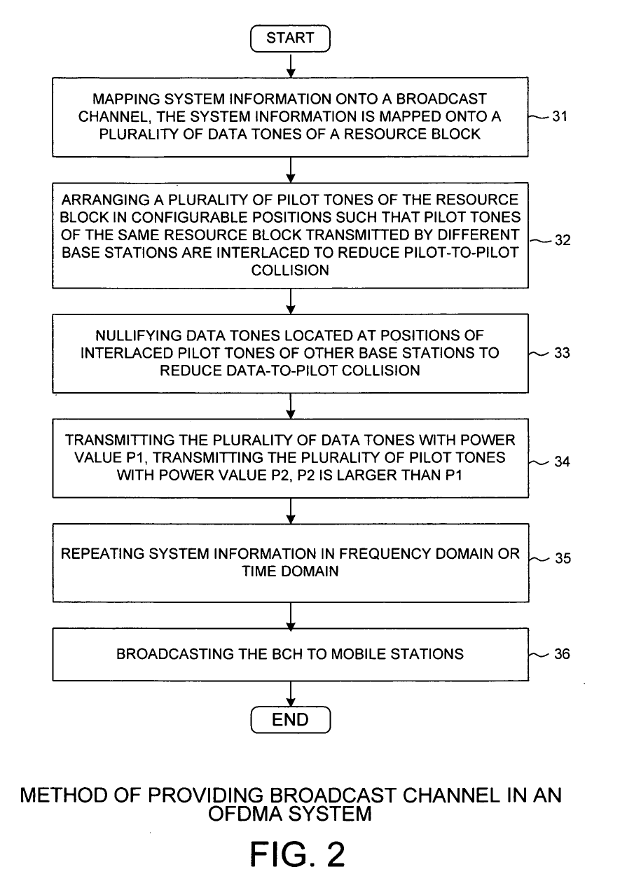

FIG. 2 is a flow chart of a method of broadcasting a common broadcast channel (BCH) in wireless OFDMA systems in accordance with one novel aspect. In step 31, each base station its system information onto one or more resource blocks of the BCH. Each resource block comprises a plurality of pilot tones and a plurality of data tones. The plurality of pilot tones is positioned in configurable locations in each resource block such that pilot tones of the same resource block transmitted by different base stations are interlaced to reduce pilot-to-pilot collision (step 32). In addition, data tones located at positions of all interlaced pilot patterns are optionally nullified to reduce data-to-pilot collision (step 33). In step 34, the transmitting power values of the pilot tones and the data tones are optionally adjusted to further improve the performance of channel estimation. In addition, the system information is optionally repeated in either frequency domain or time domain or both to improve the performance of data decoding rate (step 35). Finally, each base station broadcasts the common BCH to mobile stations (step 36). Different examples and embodiments of different schemes and options of the BCH broadcasting method are now described below with more details.

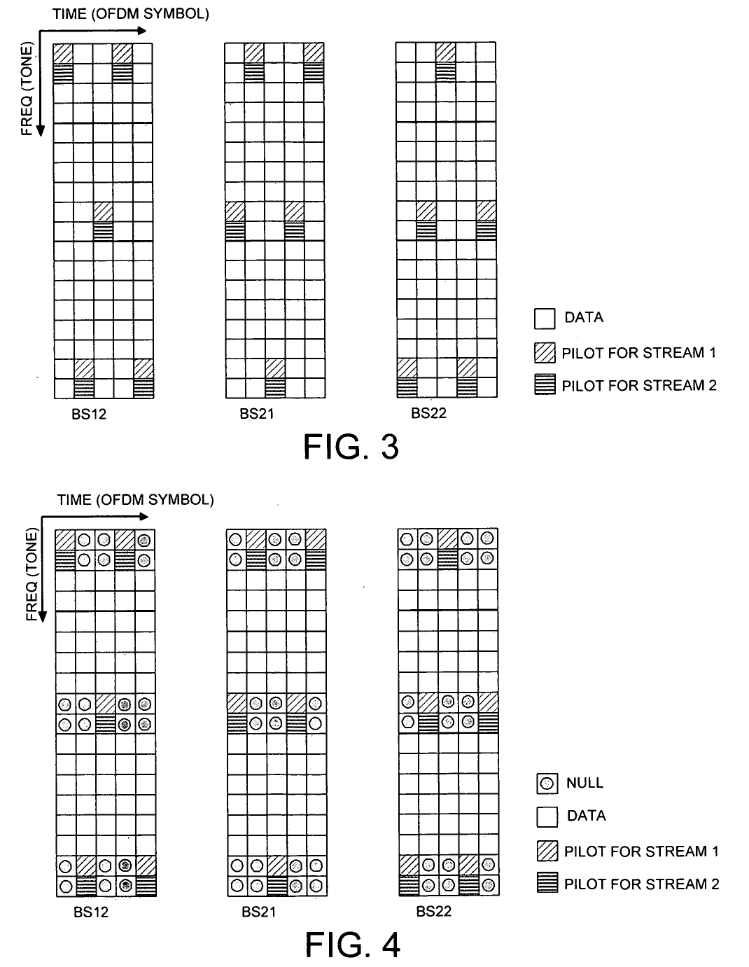

FIG. 3 illustrates one example of interlaced pilot pattern for broadcasting system information via resource block 30 in wireless OFDMA system 10. In the example of FIG. 3, pilot tones of resource block 30 transmitted by three adjacent cells BS12, BS21, and BS22 are interlaced such that their pilot tones do not collide with each other. More specifically, each base station transmits its system information over the same resource block 30 with three different pilot patterns to reduce inter-cell pilot-to-pilot collision. The selection of pilot patterns can be a function of cell identification information. In one example, each cell positions its pilot tones in interlaced locations in resource block 30 based on its cell ID. In another example, in a three-segment deployment, each segment broadcasts its system information with a different pilot pattern in resource block 30. By having interlaced pilot patterns for adjacent cells, channel estimation quality in each cell is much improved than non-interlaced pilot pattern scenario.

FIG. 4 illustrates one example of null-tone based interlaced pilot pattern for broadcasting system information via resource block 30 in wireless OFDMA system 10. While interlaced pilot pattern reduces inter-cell pilot-to-pilot collision, it does not reduce inter-cell data-to-pilot collision. In the example of FIG. 4, data tones of one cell (i.e., BS12) that are located in pilot positions of other adjacent cells (i.e., BS21 and BS22) are nullified so that they are no longer available for data transmission. By nullifying data tones located in interlaced pilot tones for other adjacent cells, interference on pilot tones due to inter-cell data-to-pilot collision is reduced, and channel estimation quality is further improved. Because of improved channel estimation quality, higher MCS can be applied and the capacity of BCH is effectively enlarged.

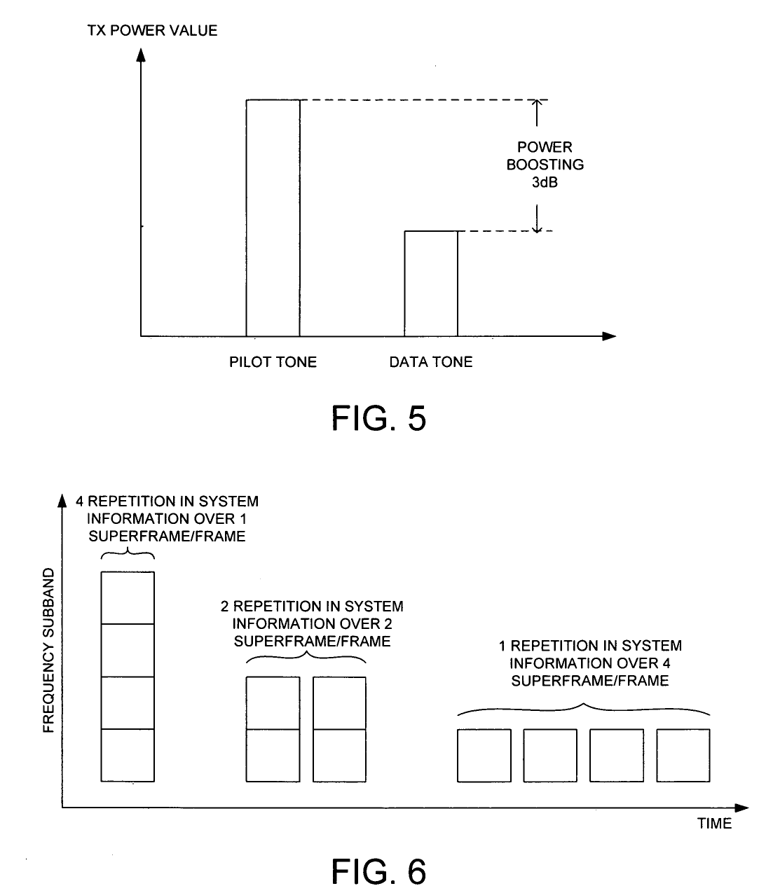

FIG. 5 illustrates one example of pilot power boosting for broadcasting system information. In wireless OFDMA systems, higher transmitting power value for pilot tones generally improves the performance of channel estimation. However, power posting for pilot tones would introduce undesirable power fluctuation. To minimize power fluctuation, when the transmit power values for pilot tones are boosted, the transmit power values for data tones are deboosted such that the total transmit power per OFDM symbol per data stream remains the same. As illustrated in FIG. 5, the transmitting power value for pilot tones is larger than 3 dB above the transmitting power value for data tones. In a first example of interlaced pilot pattern as shown in FIG. 3, such pilot power boosting is necessary to improve channel estimation quality. On the other hand, in a second example of null-tone based pilot pattern as shown in FIG. 4, pilot power boosting is optional because there is no inter-cell data-to-pilot collision. Nonetheless, power boosting for pilot tones can further improve channel estimation quality.

FIG. 6 illustrates different examples of 2D repetition for broadcasting system information. In wireless OFDMA systems, detection reliability of critical system information can be improved if the critical system information is repeated in frequency domain or time domain or both. Under frequency domain repetition, the system information is repeated in multiple frequency subbands by each base station and then broadcasted to mobile stations over a BCH. The mobile stations then use maximum ratio combining (MRC) to detect the transmitted system information by combining from the multiple frequency subbands. MRC is a method of diversity combining in which the signals from each subband are added together, and the gain of each subband is made proportional to the signal level and inversely proportional to the mean square noise level in that subband. Under time domain repetition, the system information is repeated in OFDM symbols of different superframes or frames by each base station and then broadcasted to mobile stations over a BCH. The mobile stations use soft combining to detect the transmitted system information. Soft combining is a method of combining repeated data bursts from different time frames into a single data burst so as to improve decoding performance.

There are different ways to implement the 2D repetition scheme for broadcasting system information. As illustrated in FIG. 6, in a first example, system information is repeated four times in frequency domain and one time in time domain. In a second example, system information is repeated two times in frequency domain and two times in time domain. In a third example, system information is repeated one time in frequency domain and four times in time domain. The different 2D repetition patterns need to be communicated to the mobile stations for decoding. In one embodiment, system information is mapped into a first information bit stream and a second information bit stream. The first information bit stream indicates a 2D repetition pattern, while the second information bit stream carriers the actual content of system information. For example, the 2D repetition pattern information can be represented by MCS information. Upon receiving the broadcasted system information, the mobile stations decode the first information bit stream and derive the 2D repetition pattern, and then decode the second information bit stream according to the 2D repetition pattern.

While the above-illustrated schemes relate to broadcasting system information on the transmitter side of base stations to improve channel estimation performance, it is possible to leverage some of the transmitting schemes on the receiver side of mobile stations to facilitate receiver implementation and to improve receiver performance. In conventional receiver implementation, only the pilot pattern of a serving base station is used to estimate channel response and to estimate interference second-order statistics. Such estimation, however, is inaccurate because interference characteristics of pilot tones are different from those of data tones. It is thus impossible to estimate correct second-order statistics of pure interfering data using pilot tones. In one novel aspect, the property of interlaced pilot patterns can be leveraged to estimate interference second-order statistics, which in turn facilitates receiver implementation. In addition, by combining tone nullification, it is possible to obtain more accurate interference second-order statistics and further improve receiver performance.

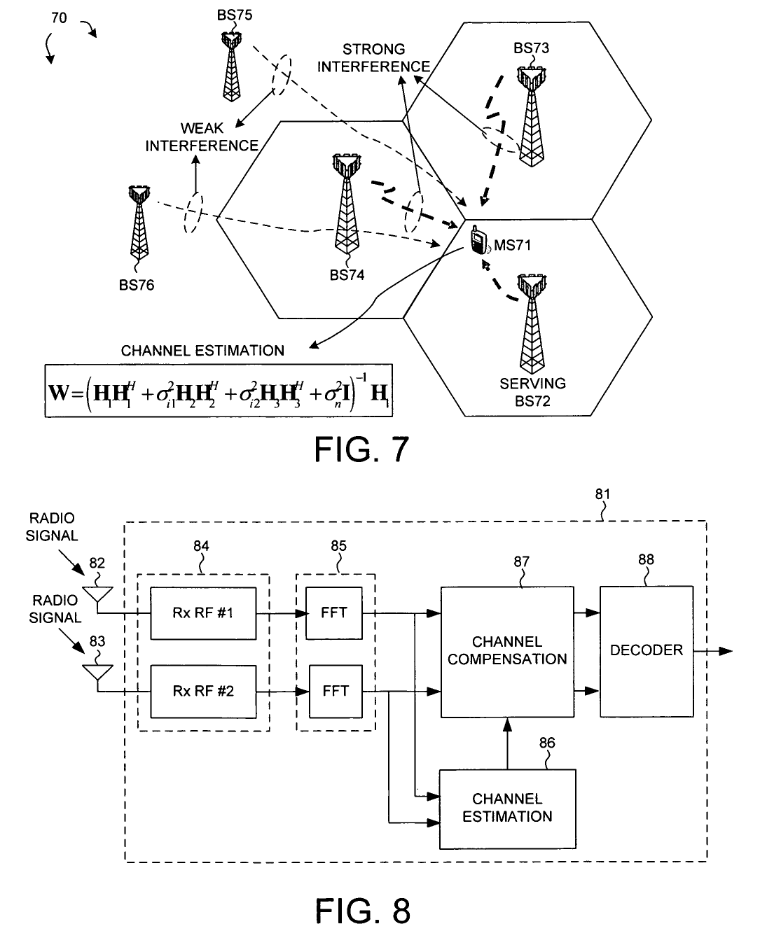

FIG. 7 illustrates a wireless OFDMA system 70 in accordance with one novel aspect. Wireless OFDMA system 70 comprises a mobile station MS71, a serving base station BS72, and interfering base stations BS73, BS74, BS75, and BS76. In the example of FIG. 7, BS72, BS73 and BS74 are neighboring cells and form a three-cell communication scenario. Interfering BS73 and BS74 are located closer to serving BS72 and transmit stronger interfering radio signals to MS71. On the other hand, BS75 and BS76 are located further to serving BS72 and transmit weaker interfering radio signals to MS71. In one novel aspect, three neighboring base stations BS72-BS74 use three interlaced pilot patterns in transmitting radio signals, and based on the predefined interlaced pilot patterns, MS71 performs channel estimation and channel compensation with improved receiver performance.

FIG. 8 illustrates a simplified block diagram of a receiver 81 of a mobile station with interlaced pilot pattern exploitation for channel estimation and compensation. Receiver 81 comprises an Rx radio frequency (RF) module 84 that receives RF signals through antennas 82 and 83, a FFT module 85 that transfers the received RF signals from time domain to frequency domain, a channel estimation module 86, a channel compensation module 87, and a decoder 88. With more details illustrated below, channel estimation module 86 exploits the predefined interlaced pilot patterns to more accurately estimate channel responses, and channel compensation module 87 suppresses interference contributed from interfering cells and detects data from serving cell based on the more accurately estimated channel responses.

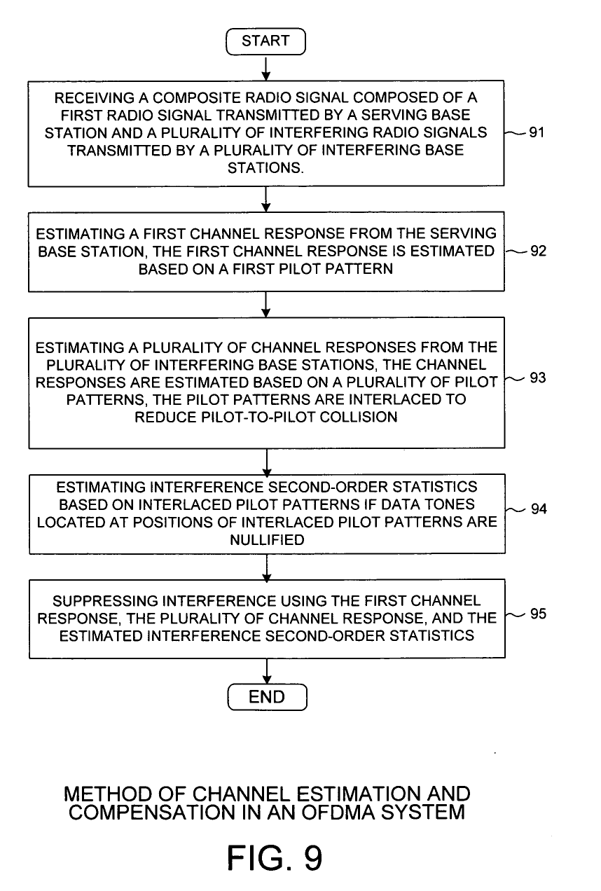

FIG. 9 is a flow chart of a method for channel estimation and compensation of a receiver in accordance with a novel aspect. In step 91, a mobile station receives a composite radio signal composed of a first radio signal and a plurality of interfering radio signals. The first radio signal is transmitted by its serving base station over radio resource blocks having a first pilot pattern. The plurality of radio signals are transmitted by a plurality of interfering base stations over radio resource blocks having a plurality of corresponding pilot patterns. The first pilot pattern and the plurality of pilot patterns are predefined and interlaced. The mobile station then estimates a first channel response of the serving BS based on the first pilot pattern (step 92). The mobile station also estimates a plurality of channel responses of the plurality of the interfering BSs based on the plurality of corresponding pilot patterns (step 93).

In a 3-cell communication scenario having one serving base station and two interfering base stations as depicted in FIG. 7 (i.e., ignoring weak interfering sources BS75 and BS76), serving BS72 allocates pilot tones with pilot pattern #1, interfering BS73 allocates pilot tones with pilot pattern #2, and interfering BS74 allocates pilot tones with pilot pattern #3. Because the pilot locations for all three interlaced pilot patterns are predefined, MS71 thus estimates a first channel response from serving BS72 using pilot pattern #1, a second channel response from interfering BS73 using pilot pattern #2, and a third channel response from interfering BS74 using pilot pattern #3. In one embodiment, if Maximum Mean Square Error (MMSE) is adopted, then the MMSE weight W for a specific frequency tone is:

W=(HᵢH₁^{H}+σᵢ₁²H₂H₂^{H}+σᵢ₂²H₃H₃^{H}+σₙ²I)⁻¹H₁ (1)

where H₁ is the channel frequency response of serving BS72, H₂ is the channel frequency response of interfering BS73, H₃ is the channel frequency response of interfering BS74, σ²ₙ is the noise power, and I represents an identity matrix. Applying equation (1) with respect to FIG. 7, MS71 uses pilot pattern #1 to estimate H₁, uses pilot pattern #2 to estimate σᵢ₁H₂, and uses pilot pattern #3 to estimate σᵢ₂H₃. By using different pilot patterns to estimate different channel responses from different base stations, the overall performance of channel estimation is improved.

In some wireless OFDMA systems, the number of interfering base stations may be larger than the number of interlaced pilot patterns. In the example of FIG. 7, there are four interfering sources BS73-BS76, with BS73-BS74 as the two stronger interfering sources with interlaced pilot patterns, and BS75-BS76 as the two weaker interfering sources without interlaced pilot patterns. Referring back to FIG. 9, in order to achieve optimal receiver performance, the mobile station also estimates interference second-order statistics based on the interlaced pilot patterns (step 94). Finally, the mobile station suppresses interference based on the estimated channel response and interference second-order statistics (step 95).

For an MMSE receiver, the optimal MMSE weight W for a specific frequency tone is:

$$W = {( \begin{matrix}{H}_{1} {H}_{1}^{H} + {σ}_{i 1}^{2} {H}_{2} {H}_{2}^{H} + {σ}_{i 2}^{2} {H}_{3} {H}_{3}^{H} + \\ {R}_{l , 1} + {R}_{l , 2} + {R}_{l , 3} - ( \frac{3}{a} - 1 ) \cdot {σ}_{n}^{2} I\end{matrix} )}^{- 1} {H}_{1} \qquad ( 2 )$$

where H₁ is the channel frequency response of serving BS72, H₂ is the channel frequency response of interfering BS73, H₃ is the channel frequency response of interfering BS74, R_{I,K} is the second-order statistics of interference estimated by using pilot pattern K, a is the power boosting factor, σ²ₙ is the noise power, and I represents an identity matrix. Applying equation (2) with respect to FIG. 7, MS71 uses pilot pattern #1 to estimate H1 and R_{I,1}, uses pilot pattern #2 to estimate H2 and R_{I,2}, and uses pilot pattern #3 to estimate H3 and R_{I,3}.

The estimated interference second-order statistics R_{I,K} represents weak interference contributed from weak interfering sources BS75 and BS76. In order to achieve the optimal MMSE weight W, both interlaced pilot pattern and tone nullification should be applied on the transmitter side by neighboring base stations BS72, BS73 and BS74. This is because with tone nullification, weak interfering radio signals transmitted from BS75 and BS76 can be accurately estimated when there is no data-to-pilot interference from BS73 and BS74. In addition, better channel response can be estimated for H1, H2 and H3 without inter-cell data-to-pilot collision.

On the other hand, in order to achieve a suboptimal MMSE weight W, the weak interference can be treated as white noise. The suboptimal MMSE weight W for a specific frequency tone is:

W=(H₁H₁^{H}+σᵢ₁²H₂H₂^{H}+σᵢ₂²H₃H₃^{H}+(σₙ²+σ_{i,other}²)I)⁻¹H₁ (3)

where H₁ is the channel frequency response of serving BS72, H₂ is the channel frequency response of interfering BS73, H₃ is the channel frequency response of interfering BS74, σ²ₙ is the while noise, and σ²_{i,other} is the weak interference contributed from interfering cells BS75 and BS76 being represented as white noise.

The broadcasting and receiving techniques described above may be implemented in hardware, software, or a combination thereof. For example, the broadcasting and receiving techniques may be implemented with modules (e.g., procedures, functions, etc.) that perform the procedures and functions. The firmware or software codes may be stored in a memory unit (i.e., storage device 24 or 14 of FIG. 1) and executed by a processor (i.e., processor 25 or 14 of FIG. 1).

Although the present invention has been described in connection with certain specific embodiments for instructional purposes, the present invention is not limited thereto. For example, the system information broadcasted via a BCH is not necessary the SFH information defined in the IEEE 802.16m specification. Instead, it may include system information defined by wireless systems such as 3GPP LTE. In 3GPP LTE, some of the critical system information includes essential physical layer information of the cell required to receive further system information, information relevant when evaluating if a UE is allowed to access a cell and defined the scheduling of other system information blocks, common and shared channel information, cell re-selection information, etc. In addition, the receiver architecture illustrated in FIGS. 7-9 is not limited to be a linear MMSE receiver. Instead, it can be any detection system with interference mitigation, suppression, pre-whitening method requires interference second-order statistics. For example, it can be a successive interference suppressor (SIC), a parallel interference suppressor (PIC), and an interference/noise pre-whitener. Accordingly, various modifications, adaptations, and combinations of various features of the described embodiments can be practiced without departing from the scope of the invention as set forth in the claims.

What is claimed is:

1. A method for providing a broadcast channel (BCH) in a cellular OFDMA system, the method comprising:
mapping system information onto the BCH by a base station, wherein the BCH comprises one or more two-dimensional resource blocks, each resource block has an array of subcarriers along frequency domain and an array of OFDM symbols along time domain; and
broadcasting the BCH in the OFDMA system, wherein each resource block comprises a plurality of pilot tones and a plurality of data tones, wherein the system information is mapped onto the plurality of data tones, and wherein the plurality of pilot tones are located in configurable positions such that pilot tones of the same resource blocks transmitted by different base stations in the OFDMA system are interlaced to reduce pilot-to-pilot collision.

2. The method of claim 1, wherein the plurality of pilot tones is positioned at least in part based on cell identification information of the base station.

3. The method of claim 1, wherein the plurality, of pilot tones is transmitted with a higher power value than the plurality of data tones.

4. The method of claim 1, wherein data tones of the base station located at positions of pilot tones of other base stations in the OFDMA system are nullified to reduce data-to-pilot collision.

5. The method of claim 4, wherein the system information is repeated either in frequency domain or in time domain.

6. The method of claim 1, wherein the system information is repeated either in frequency domain or in time domain.

7. The method of claim 6, wherein the system information is mapped into a first bit stream and a second bit stream, wherein the first bit stream indicates repetition patterns in frequency domain and in time domain of the second bit stream.

8. A base station, comprising:
a transmitter that maps system information onto a broadcast channel (BCH) in a cellular OFDMA system, wherein the BCH comprises one or more two-dimensional resource blocks, each resource block has an array of subcarriers along frequency domain and an array of OFDM symbols along time domain; and
a transmitting antenna that broadcasts the BCH to mobile stations, wherein each resource block comprises a plurality of pilot tones and a plurality of data tones, wherein the system information is mapped onto the plurality of data tones, and wherein the plurality of pilot tones are located in configurable positions such that pilot tones of the same resource blocks transmitted by different base stations in the OFDMA system are interlaced to reduce pilot-to-pilot collision.

9. The base station of claim 8, wherein the plurality of pilot tones is positioned at least in part based on cell identification information of the base station.

10. The base station of claim 8, wherein the plurality of pilot tones is transmitted with a higher power value than the plurality of data tones.

11. The base station of claim 8, wherein data tones of the base station located at positions of pilot tones of other base stations in the OFDMA system are nullified to reduce data-to-pilot collision.

12. The base station of claim 11, wherein the system information is repeated either in frequency domain or in time domain.

13. The base station of claim 8, wherein the system information is repeated either in frequency domain or in time domain.

14. The base station of claim 13, wherein the system information is mapped into a first bit stream and a second bit stream, wherein the first bit stream indicates repetition patterns in frequency domain and in time domain of the second bit stream.

15. A method, comprising:
(a) estimating a first channel response from a serving base station in a cellular OFDM system, wherein the first channel response is estimated by a mobile station based on a first pilot pattern used by the serving base station;
(b) estimating a plurality of channel responses from a plurality of interfering base stations, wherein the channel responses are estimated by the mobile station based on a plurality of pilot patterns used by the plurality of interfering base stations, and wherein the first pilot pattern and the plurality of pilot patterns are interlaced to reduce pilot-to-pilot collision; and
(c) suppressing interference using the first channel response and the plurality of channel responses.

16. The method of claim 15, wherein the estimating in (a) and (b) are performed by a linear Minimum Mean Square Error (MMSE) receiver.

17. The method of claim 15, wherein the interlaced pilot patterns are positioned based on cell identification information of each base station.

18. The method of claim 15, wherein the mobile station suffers additional weak interfering sources, and wherein the weak interfering sources are treated as white noise.

19. The method of claim 15, wherein data tones located at all positions of interlaced pilot patterns are nullified to reduce data-to-pilot collision.

20. The method of claim 19, wherein the mobile station suffers additional weak interfering sources, the method further comprising:
estimating interference second-order statistics from the weak interfering sources based on all interlaced pilot patterns.

21. The method of claim 20, wherein the suppressing in (c) also uses the estimated interference second-order statistics.

22. A receiver, comprising:
a receiving radio frequency (RF) module that receives a composite radio signal composed of a first radio signal with a first pilot pattern transmitted by a serving base station and a plurality of radio signals with a plurality of pilot pattern transmitted by a plurality of interfering base stations, wherein the first pilot pattern and the plurality of pilot patterns are interlaced to reduce pilot-to-pilot collision;
a channel estimation module that estimates a first channel response based on the first pilot pattern, and estimates a plurality of channel responses based on the corresponding plurality of pilot patterns; and
a channel compensation module that suppresses interference using the first channel response and the plurality of channel responses.

23. The receiver of claim 22, wherein the receiver is a linear Minimum Mean Square Error (MMSE) receiver.

24. The receiver of claim 22, wherein the interlaced pilot patterns are positioned based on cell identification information of each base station.

25. The receiver of claim 22, wherein the receiver suffers additional weak interfering sources, and wherein the weak interfering sources are treated as white noise.

26. The receiver of claim 22, wherein data tones located at all positions of interlaced pilot patterns are nullified to reduce data-to-pilot collision.

27. The receiver of claim 26, wherein the receiver suffers additional weak interfering sources, wherein the channel estimation module also estimates interference second-order statistics from the weak interfering sources based on all interlaced pilot patterns.

28. The receiver of claim 27, wherein the channel compensation module also uses the estimated interference second-order statistics to suppresses interference.
